(19) United States
(12) Patent Application Publication
(10) Pub. No.: US 2012/0292365 A1
(43) Pub. Date: Nov. 22, 2012

(54) BOLT TOOL AND METHOD FOR OPERATING A BOLT-SETTING TOOL

(75) Inventors: Dierk TILLE, Konstanz (DE); Ulrich Rosenbaum, Wangs (CH)

(73) Assignee: Hilti Aktiengesellschaft, Schaan (LI)

(21) Appl. No.: 13/473,768

(22) Filed: May 17, 2012

(30) Foreign Application Priority Data
May 20, 2011 (DE) 10 2011 076158.6

(51) Int. Cl. B25C 5/00

(52) U.S. Cl. 227/99

(57) ABSTRACT

The invention concerns a bolt-setting tool for setting fastening elements in a substrate, with a trigger (15) that can be moved by application of a force against a counterforce to trigger a setting operation.

In order to make further improvement in the operation of the bolt-setting tool, a counterforce-generating device (20) with a counterforce-travel curve that has a local maximum (34) is associated with the trigger (15).

### TECHNICAL FIELD

The invention concerns a bolt-setting tool for setting fastening elements in a substrate, with a trigger that can be moved by applying a force against a counterforce in order to initiate a setting operation. The invention additionally concerns a method for operating such a bolt-setting tool.

1. Prior Art

A fuel-operated setting tool with a propellant and an igniter unit, which can be actuated via a trigger switch on a handle of the setting tool, is known from the German Patent Application [Offenlegungsschrift] DE 10 2005 000 032 A1.

2. Nature of Invention

The task of the invention is to make further improvement in the use of a bolt-setting tool as in the generic part of claim 1.

The task is solved in the case of a bolt-setting tool for setting fastener elements into a substrate, with a trigger that can be moved by applying a force against a counterforce in order to initiate a setting operation, in that associated with the trigger is a counterforce-generating device with a counterforce-travel curve that has a local maximum. An actuator or release mechanism of the bolt-setting tool is called the trigger. When the trigger is actuated, a bolt, for example, is set. Before setting of a bolt, the bolt-setting tool is pressed against a substrate into which the bolt is supposed to be set. Through the pressing of the bolt-setting tool against the substrate, the implementation of preparatory steps for setting the bolt in the bolt-setting tool can be unblocked. The actual setting operation is initiated by the actuation, i.e., pulling or pressing, of the trigger. Through the local maximum in the counterforce-travel curve is provided a counterforce peak, which reliably prevents unintentional triggering of a setting operation. Moreover, the quality of setting can be improved through the counterforce-travel curve in accordance with the invention.

A preferred embodiment example of the bolt-setting tool is characterized in that the counterforce rises linearly before and/or after the local maximum. The counterforce steadily rises, preferably from zero up to the local maximum, upon application of an actuation force to the trigger. Then the counterforce falls, preferably instantaneously, to a low value. From the said low value the counterforce then rises, again preferably linearly.

Another preferred embodiment example of the bolt-setting tool is characterized in that the counterforce, after the local maximum, has a local minimum. The transition from local maximum to local minimum takes place instantaneously or abruptly, preferably through a snap action or clicker effect.

Another preferred embodiment example of the bolt-setting tool is characterized in that the counterforce rises more steeply before the local maximum than after the local maximum or the local minimum. The counterforce preferably rises clearly more steeply before the local maximum than after the local maximum or after the local minimum.

Another preferred embodiment example of the bolt-setting tool is characterized in that the counterforce after the local maximum up to an end point remains less than at the local maximum. At the end point the counterforce preferably has an end value that is less than half the local maximum.

Another preferred embodiment example of the bolt-setting tool is characterized in that the local maximum is disposed before at least one path point, at the reaching of which a specific function of the bolt-setting tool is initiated. The local maximum is preferably disposed before a plurality of path points, at the achievement of each of which a defined function of the bolt-setting tool is initiated. After the abrupt or instantaneous drop of the counterforce, the trigger is again moved preferably with a relatively large actuation force, which was necessary to overcome the local counterforce maximum. In this way the trigger is moved in an especially advantageous way rapidly up to the end point, through which all defined functions of the bolt-setting tool are reliably triggered.

Another preferred embodiment example of the bolt-setting tool is characterized in that the local maximum is disposed before a path point, upon the achievement of which a setting operation is triggered. A delayed exit of the bolt from the setting tool can be prevented through the counterforce-travel curve in accordance with the invention.

Another preferred embodiment example of the bolt-setting tool is characterized in that the counterforce-generating device comprises a counterforce spring. The counterforce spring is preferably designed similar to or exactly like a clicker spring, as in a toy. A clicker spring is made, for example, from a strip of spring steel that is shaped or stamped so that when a force is applied to it, it springs back suddenly and instantaneously, producing a clicking noise.

Another preferred embodiment example of the bolt-setting tool is characterized in that the counterforce spring is made as a leaf spring with a curvature. Through the curvature, a sudden change, in particular a sudden steady decrease, of the counterforce produced by the spring, from a local counterforce maximum to a local counterforce minimum, is achieved upon application of an actuating force.

Another preferred embodiment example of the bolt-setting tool is characterized in that the counterforce spring has two support points and a force introduction point. The force introduction point is preferably disposed essentially in the middle between the two support points at the ends of the leaf spring. An alternative embodiment example of the bolt-setting tool is characterized in that the counterforce spring has exactly one support point and one force introduction point.

In a method for operating a bolt-setting tool described above, the task indicated above is alternatively or additionally solved in that upon the application of a force to the trigger a counterforce peak must be overcome before a setting operation is triggered. The counterforce peak corresponds to the local maximum in the counterforce-travel curve and therefore is also called the counterforce maximum. After overcoming the force peak, a user pulls or presses the trigger automatically to the end point. Through this it is ensured that all of the defined functions are triggered within a short period of time.

Additional advantages, characteristics and details of the invention result from the following description, in which different embodiment examples are described in detail with reference to the drawings. Here:

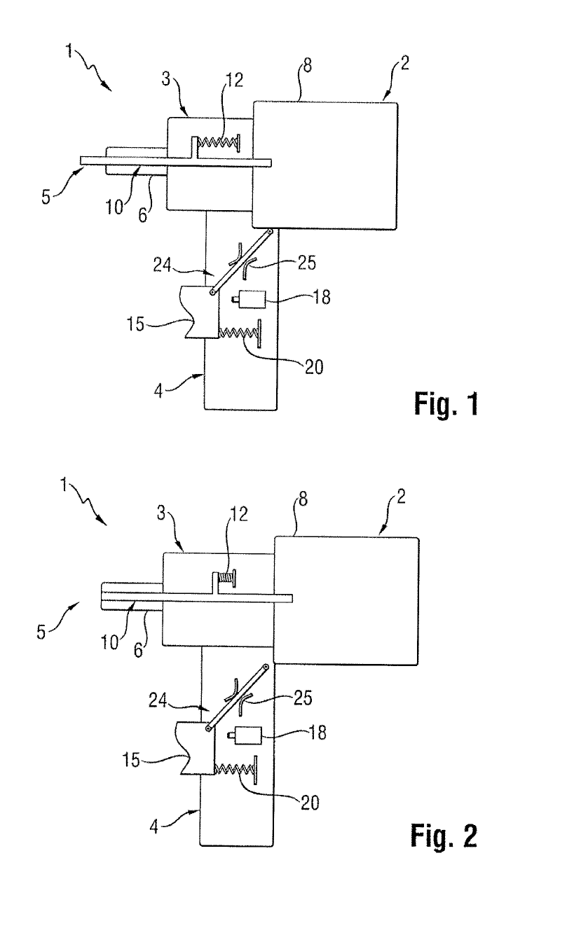

FIG. 1 shows a simplified representation of a bolt-setting tool with a counterforce-generating device in an uncocked state not pressed against a substrate;

FIG. 2 shows the bolt-setting tool from FIG. 1 in a state pressed against a substrate;

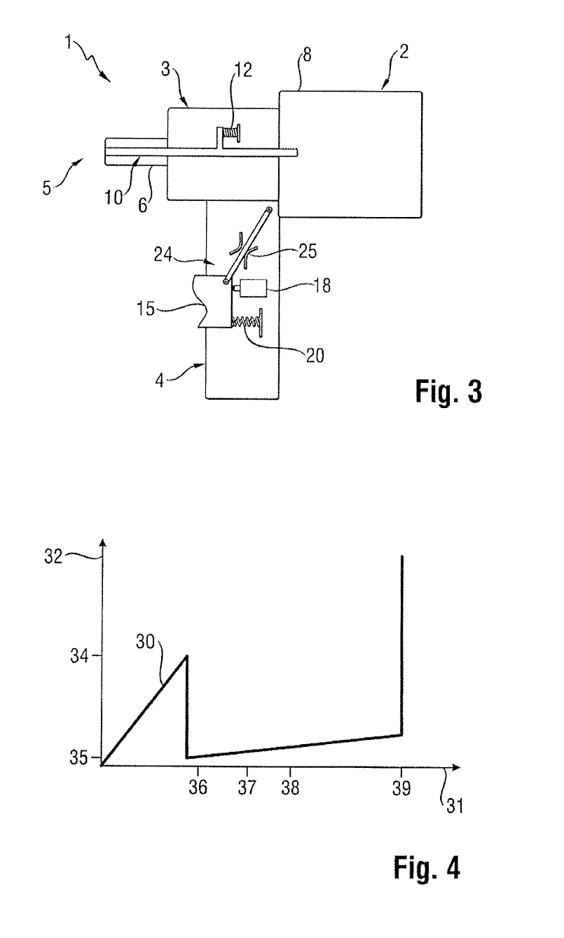

FIG. 3 shows the bolt-setting tool from FIG. 2 with actuated trigger;

FIG. 4 shows a Cartesian coordinate diagram with a characteristic curve that represents a counterforce-travel curve in accordance with the invention;

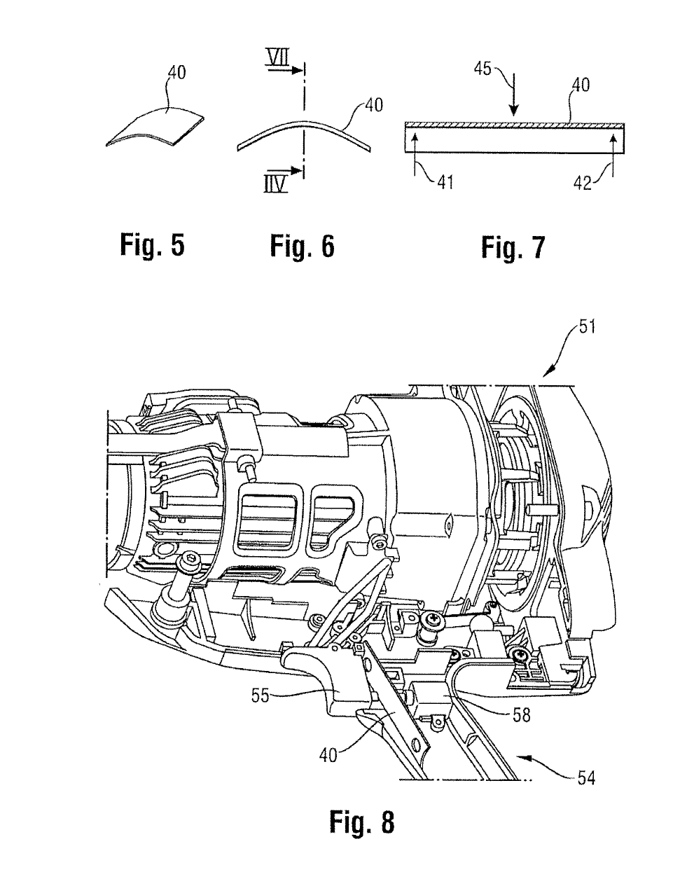

FIG. 5 shows a perspective drawing of a counterforce spring, with which a counterforce-travel curve, as indicated in FIG. 4, can be represented;

FIG. 6 shows a front view of the counterforce spring from FIG. 5;

FIG. 7 shows a section along line VII-VII in FIG. 6, and

FIG. 8 shows a perspective drawing of an opened housing of a bolt-setting tool, showing a trigger and a counterforce spring, as represented in FIGS. 5-7.

### EMBODIMENT EXAMPLES

FIGS. 1-3 show a bolt-setting tool 1 in various states. The bolt-setting tool 1 comprises a housing 2 with a cylinder 3 and a handle 4. The bolt-setting tool 1 can be gripped at the handle 4 for driving a fastening element, which emerges from a bolt guide 6 at a bolt-setting end 5.

Energy is required to drive the fastening elements into a substrate; the said energy can be made available, for example, in a gas cartridge within the bolt-setting tool. The gas cartridge can be connected to a combustion chamber in a combustion chamber sleeve 8 via a dispensing valve. In the combustion chamber, gas from the gas cartridge is mixed with air to form a combustible mixture, which is ignited in order to make available the energy required to drive the bolt into the substrate.

Before a bolt-setting operation the bolt-setting tool 1 must be pressed against the substrate in order to put it into a setting-ready state. When the bolt-setting tool 1 is pressed against a substrate, a pressing rod assembly 10 is moved against the pretension of a pressure spring 12 into the bolt-setting tool 1 until the bolt-setting end 5 lies flush against the substrate.

After the bolt-setting tool 1 is pressed into the substrate, the setting operation is triggered by a trigger 15. The trigger 15 interacts with a switch device 18, which, for example, sends a signal to set a bolt to a control unit, which in turn triggers the ignition of the ignitable mixture in the combustion chamber in the combustion chamber sleeve 8. Here the trigger 15 can have both control and signaling functions.

Upon actuation, i.e., pulling or pressing, of the trigger 15, it moves against a counterforce of a counterforce-generating device 20 up to the switch device 18. The counterforce-generating device 20 preferably comprises a counterforce spring as represented in FIGS. 5-7. The counterforce spring preferably has a counterforce-travel curve as shown in FIG. 4.

A bracket 24, which is guided in a specially made support 25 in a housing wall of housing 2 in handle 4 of the bolt-setting tool 1, is hinged to the trigger 15. In the “uncocked” state of the tool shown in FIG. 1, the bracket 24 rests against the combustion chamber sleeve 8, through which it, in combination with its support 25, blocks the actuation of the trigger 15.

When the bolt-setting tool has been completely pressed against the substrate, as shown in FIG. 2, the bracket 24 and thus the trigger 15 become unblocked from the combustion chamber sleeve 8. One can see in FIG. 3 that when the unblocked trigger 15 is pulled, the switch device 18 is actuated, so that a signal is generated. At the same time the bracket 24, because of its support 25, makes a swinging motion to a recess or into a concave geometry of the combustion chamber sleeve 8, so that it becomes blocked in the axial direction by the bracket 24.

In view of the functions that take place during the setting operation, it is advantageous that the trigger 15 reserves as large as possible an actuation path between the individual functions, controlling and/or signaling. Through this a desired sequence of functions is ensured. In addition, the effect of part tolerances will be minimized. Moreover, if the setting frequency is slow, the bolt-setting tool will be insensitive to different user behaviors.

However, if there is a rapid setting frequency, a large actuation path can increase the effect of user behavior. It may happen, for example, that the bolt-setting tool 1 is already lifted a little from the substrate before the trigger 15 is completely pulled. Because of inertia, the bolt-setting tool briefly remains in the cocked state after being lifted, so that the trigger 15 can be pulled. In this case it can happen that a bolt exits the bolt-setting tool late, which leads to poor setting quality, since the bolt guide 6 that guides the bolts is no longer connected to the substrate.

According to an important aspect of the invention, the counterforce-generating device 20 has a particular counterforce-travel curve, which is represented in FIG. 4 by a characteristic curve 30 in a Cartesian coordinate diagram. The Cartesian coordinate diagram comprises an x axis 31 and a y axis 32. The counterforce that is generated by the counterforce generation device 20 is plotted in Newtons on the y axis 32. The associated travel of the trigger 15 is plotted in millimeters on the x axis 31. The signaling and/or controlling functions of the trigger 15 can be reliably satisfied in a simple way through the characteristic curve 30. Through this a high setting quality can be ensured even if there is a rapid setting frequency.

The characteristic curve 30 of the counterforce-generating device 20 initially rises from zero to a local maximum 34. The local maximum corresponds to a counterforce peak that confers a clear pressure point behavior on trigger 15. Here the counterforce-generating device 20 in accordance with the invention is designed so that the counterforce drops off instantaneously or abruptly to a local minimum 35 after the local maximum 34. After the local minimum 35 the curve 30 rises linearly, but with a clearly lower slope than before the local maximum 34.

Signaling and/or controlling functions 35, 37 and 38 are triggered after passing through the local maximum 34 and the local minimum 35. The user cannot react so quickly after the drop off of the counterforce from the local maximum 34 to the local minimum 35 and therefore continues to press trigger 15 with a relatively high initial actuation force, which must be greater than the local maximum 34. As a result, the trigger 15 will be pulled or pressed very rapidly up to a stop at the path end 39 of the trigger 15, so that all functions 36 through 38 are reliably initiated. Through this the effect of user behavior is reduced.

Sufficient play can be built in between the individual functions 36-38 of the trigger 15. Through this the effect of part tolerances can be reduced. A delayed exit of a bolt after lifting the bolt-setting tool 1 from the substrate is no longer possible, since ignition will occur only as long as the bolt-setting end 5 of the bolt-setting tool is still pressed against the substrate. This leads on the one hand to better setting quality and on the other to an improvement in safety.

Another advantage lies in the fact that the user receives unambiguous tactile feedback indicating that he has actuated the trigger 15. In this way he can better recognize when the bolt-setting tool has been triggered. This is especially useful when a very precise setting point is required. The user can, while he takes aim with the bolt-setting end 5, leave a finger lying on the trigger 15 without having to be afraid that he will overcome the counterforce peak with a relatively small applied force and initiate an undesired setting.

FIGS. 5-7 show the counterforce spring 40 in different views. The counterforce spring 40 is designed as a curved leaf spring, which is supported at two support points 41 and 42 at its ends in the handle of the bolt-setting tool. A clicker effect results from the curved shape of the leaf spring 40, where the user must overcome a force peak in the form of the local maximum 34 in FIG. 4 in the first millimeters of bending of the leaf spring. After the local maximum 34, the counterforce exerted by the leaf spring 40 rapidly falls to the local minimum 35 and remains low for the remainder of the actuation path. An arrow 45 in FIG. 7 indicates that the force is applied by the trigger 15 approximately in the middle on the convex side of the curvature of the leaf spring 40.

FIG. 8 shows a perspective view of an embodiment example of a bolt-setting tool 51 with the housing opened. In a handle 54 of the bolt-setting tool 51, a counterforce spring 40, as represented in FIGS. 5-7, is mounted between a trigger 55, which corresponds to the trigger 15 in FIGS. 1-3, and a switch device 58, which corresponds to the switch device 18 in FIGS. 1-3.

1. A bolt-setting tool for setting fastening elements in a substrate, comprising a trigger, which can be moved against a counterforce by application of a force to initiate a setting operation, wherein the trigger is a counterforce-generating device with a counterforce-travel curve that has a local maximum.

2. The bolt-setting tool as in claim 1, wherein the counterforce rises linearly to the local maximum before and/or after the local maximum.

3. The bolt-setting tool as in claim 1, wherein the counterforce after the local maximum has a local minimum.

4. The bolt-setting tool as in claim 1, wherein the counterforce rises more steeply before the local maximum than after the local maximum.

5. The bolt-setting tool as in claim 1, wherein the counterforce after the local maximum remains less than the local maximum up to a path end.

6. The bolt-setting tool as in claim 1, wherein the local maximum is disposed before at least one path point, and, once at least one of the path points is reached, a defined function of the bolt-setting tool is triggered.

7. The bolt-setting tool as in claim 1, wherein the local maximum is disposed before a path point, and, once the path point is reached, a setting operation is triggered.

8. The bolt-setting tool as in claim 1, wherein the counterforce-generating device comprises a counterforce spring.

9. The bolt-setting tool as in claim 8, wherein the counterforce spring comprises a leaf spring with a curvature.

10. The bolt-setting tool as in claim 8, wherein the counterforce spring is disposed between the trigger and a switch device.

11. The bolt-setting tool as in claim 8, wherein the counterforce spring has two support points and one force introduction point.

12. The bolt-setting tool as in claim 8, wherein the counterforce spring has exactly one support point and one force introduction point.

13. A method for operating the bolt-setting tool according to claim 1, comprising applying a force to the trigger, and overcoming, a counterforce peak before triggering a setting operation.

14. The bolt-setting tool as in claim 9, wherein the counterforce spring is disposed between the trigger and a switch device.

15. The bolt-setting tool as in claim 9, wherein the counterforce spring has two support points and one force introduction point.

16. The bolt-setting tool as in claim 9, wherein the counterforce spring has exactly one support point and one force introduction point.

17. The bolt-setting tool as in claim 2, wherein the counterforce after the local maximum has a local minimum.

18. The bolt-setting tool as in claim 2, wherein the counterforce rises more steeply before the local maximum than after the local maximum.

19. The bolt-setting tool as in claim 3, wherein the counterforce rises more steeply before the local maximum than after the local maximum.

20. The bolt-setting tool as in claim 17, wherein the counterforce rises more steeply before the local maximum than after the local maximum.
